(19) United States
(12) Patent Application Publication
(10) Pub. No.: US 2026/0009163 A1
(43) Pub. Date: Jan. 8, 2026

(54) DISSOLVING AND DEGASSING EQUIPMENT

(71) Applicant: Chung Hwa Pulp Corporation, Taipei (TW)

(72) Inventors: Tao-Jung LIN, Taipei (TW); Hui-Wen HSU, Taipei (TW); Yi-Ching SUNG, Taipei (TW); Chao-Huei LIU, Taipei (TW)

(21) Appl. No.: 19/258,911

(22) Filed: Jul. 3, 2025

Related U.S. Application Data
(60) Provisional application No. 63/667,132, filed on Jul. 3, 2024.

(51) Int. Cl. D01D 1/02; B01F 21/10; B01F 27/113; B01F 35/90; D01D 1/10; D01D 13/02

(52) U.S. Cl. CPC D01D 1/02; B01F 21/10; B01F 27/113; D01D 1/103; D01D 1/106; D01D 13/02; B01F 2035/99

(57) ABSTRACT

A dissolving and degassing equipment includes a dissolution tank, a vacuum pump, a circulation pump, and at least one filter. The dissolution tank is configured to accommodate dope. The vacuum pump is connected to a top portion of the dissolution tank and is configured to remove bubbles from the dope. The circulation pump is connected to a bottom portion of the dissolution tank and is configured to draw the dope from the dissolution tank. The filter is connected to the circulation pump and the dissolution tank, and is located downstream of the circulation pump and upstream of the dissolution tank. The filter includes a plurality of sieves with different numbers of meshes, configured to capture impurities of different sizes and additional bubbles in the dope drawn from the dissolution tank.

### CROSS-REFERENCE TO RELATED APPLICATION

This application claims priority to US Provisional Application Ser. No. 63/667,132, filed Jul. 3, 2024, which is herein incorporated by reference in its entirety.

### BACKGROUND

### Technical Field

The present disclosure relates to a dissolving and degassing equipment, and more particularly, to a dissolving and degassing equipment for forming spinning stock solution.

### Description of Related Art

The production of spinning stock solution generally involves dissolving its raw materials and a solvent to form a dope, followed by processing the dope, such as steps of improving uniformity and removing bubbles, to avoid affecting the fiber quality when the spinning stock solution is subsequently used to produce fibers.

In conventional processes, although a static vacuum degassing method may be employed for the dope, in high-viscosity spinning stock solution, due to the effect of viscous resistance, it is difficult for the bubbles to diffuse to the surface of the spinning stock solution; and as the liquid level of the dope in a dissolution tank changes, the resistance to internal bubbles in the dope increases, making degassing even more difficult, thereby affecting the spinning processes in subsequent stages and the physical properties of the formed fibers.

### SUMMARY

According to some embodiments of the present disclosure, a dissolving and degassing equipment includes a dissolution tank, a vacuum pump, a circulation pump, and at least one filter. The dissolution tank is configured to accommodate dope. The vacuum pump is connected to a top portion of the dissolution tank and is configured to remove bubbles in the dope. The circulation pump is connected to a bottom portion of the dissolution tank and is configured to draw the dope from the dissolution tank. The filter is connected to the circulation pump and the dissolution tank and is located downstream of the circulation pump and upstream of the dissolution tank. The filter has plural sieves with different numbers of meshes, configured to capture impurities of different sizes and additional bubbles in the dope drawn from the dissolution tank.

In some embodiments, the sieves comprise a first sieve, a second sieve and a third sieve, the second sieve is located between the first sieve and the third sieve, such that the dope is allowed to sequentially pass through the first sieve, the second sieve and the third sieve.

In some embodiments, a number of meshes of the second sieve is greater than a number of meshes of the first sieve and a number of meshes of the third sieve, and the number of meshes of the first sieve is greater than the number of meshes of the third sieve or equal to the number of meshes of the third sieve.

In some embodiments, the number of meshes of the second sieve is 200 to 500 per square inch.

In some embodiments, the number of meshes of the second sieve is 350 to 400 per square inch.

In some embodiments, the dissolving and degassing equipment further comprises an additional filter. The additional filter is located downstream of the dissolution tank and upstream of the circulation pump, and has an additional sieve. A number of meshes of the sieve of the additional filter is less than the number of meshes of the third sieve.

In some embodiments, the dissolving and degassing equipment further comprises a switching valve located between the dissolution tank and the additional filter.

In some embodiments, the dissolving and degassing equipment further comprises a stirrer. The stirrer extends from the top portion of the dissolution tank into the dissolution tank, and is configured to enable raw materials and a solvent of spinning stock solution to be dissolved into the dope.

In some embodiments, the stirrer comprises a motor and a blade. The motor is located above the top portion of the dissolution tank. The blade is located in the dissolution tank and connected to the motor.

In some embodiments, the dissolving and degassing equipment further comprises a heating jacket and a heating and temperature controller. The heating jacket is sleeved on the dissolution tank and a circulation pipeline. The heating and temperature controller is connected to the heating jacket.

In some embodiments, the dissolving and degassing equipment further comprises a pressurization valve and a vacuum valve. The pressurization valve is connected to the top portion of the dissolution tank and an air compressor. The vacuum valve is connected to the dissolution tank and the vacuum pump.

In some embodiments, the dissolving and degassing equipment further comprises two switching valves. One of the two switching valves is located downstream of the circulation pump and upstream of the filter, and the other one of the two switching valves is located downstream of the filter and upstream of the dissolution tank.

In some embodiments, the dissolving and degassing equipment comprises a plurality of the filters, and the filters are arranged in parallel.

In some embodiments, the dissolving and degassing equipment comprises a plurality of the filters, and the filters are arranged in series.

According to some embodiments of the present disclosure, a dissolving and degassing equipment includes a dissolution tank, a stirrer, a circulation pump, and at least one filter. The dissolution tank is configured to accommodate dope. The stirrer extends from a top portion of the dissolution tank into the dissolution tank, and is configured to enable raw materials and a solvent of spinning stock solution to be dissolved into the dope. The circulation pump is connected to a bottom portion of the dissolution tank and configured to draw the dope from the dissolution tank. The filter is connected to the circulation pump and the dissolution tank and is located downstream of the circulation pump and upstream of the dissolution tank. The filter has plural sieves with different numbers of meshes, configured to capture impurities of different sizes and bubbles in the dope drawn from the dissolution tank.

In the above embodiments of the present disclosure, since the vacuum pump is connected to the top portion of the dissolution tank, the circulation pump is connected to the bottom portion of the dissolution tank, and the filter having plural sieves is connected to the circulation pump and the dissolution tank, it is possible to utilize the vacuum pump to remove gas from the high-viscosity dope in the dissolution tank, thereby promoting degassing. Furthermore, the design in which the sieves in the filter have different numbers of meshes enables the capture of impurities and additional bubbles in the dope drawn from the dissolution tank. As such, the dissolving and degassing equipment can provide a uniform, bubble-free, and impurity-free spinning stock solution, which is beneficial to the spinning processes in subsequent stages and to the physical properties of the formed fibers, thereby improving the product yield rate.

### BRIEF DESCRIPTION OF THE DRAWINGS

Aspects of the present disclosure may be best understood with reference to the following embodiments when read in conjunction with the accompanying drawings. It is noted that, according to standard practice in the industry, various features are not drawn to scale. In fact, the dimensions of various features may be arbitrarily increased or decreased for clarity of discussion.

FIG. 1 illustrates a schematic diagram of a dissolving and degassing equipment according to an embodiment of the present disclosure.

FIG. 2 illustrates an enlarged schematic diagram of a filter and a circulation pipeline of FIG. 1.

FIG. 3 illustrates an enlarged schematic diagram of the filter and the circulation pipeline according to another embodiment of the present disclosure.

FIG. 4 illustrates a schematic diagram of a heating jacket sleeved on the circulation pipeline in FIG. 1.

FIG. 5 illustrates a schematic diagram of the dissolving and degassing equipment of FIG. 1 after the filter is switched to an additional filter.

FIG. 6 illustrates a schematic diagram of the dissolving and degassing equipment of FIG. 1 when connected to a spinning equipment.

FIG. 7 illustrates a schematic diagram of a dissolving and degassing equipment according to another embodiment of the present disclosure.

### DETAILED DESCRIPTION

The embodiments disclosed below provide many different embodiments or examples for implementing various features of the provided subject matter. Specific examples of components and arrangements are described below to simplify the present case. Of course, these examples are merely examples and are not intended to be limiting. Moreover, reference numerals and/or letters in various examples may be repeated in the present case. Such repetition is for the purpose of simplicity and clarity and does not in itself indicate a relationship between the discussed embodiments and/or configurations.

Spatially relative terms such as “beneath,” “below,” “lower,” “above,” “upper,” and the like may be used herein for ease of description to describe a relationship of one element or feature to another element or feature as illustrated in the drawings. The spatially relative terms are intended to encompass different orientations of the apparatus in use or operation in addition to the orientation depicted in the drawings. The apparatus may be oriented in other ways (rotated 90 degrees or in other orientations), and the spatially relative descriptors used herein are to be interpreted accordingly.

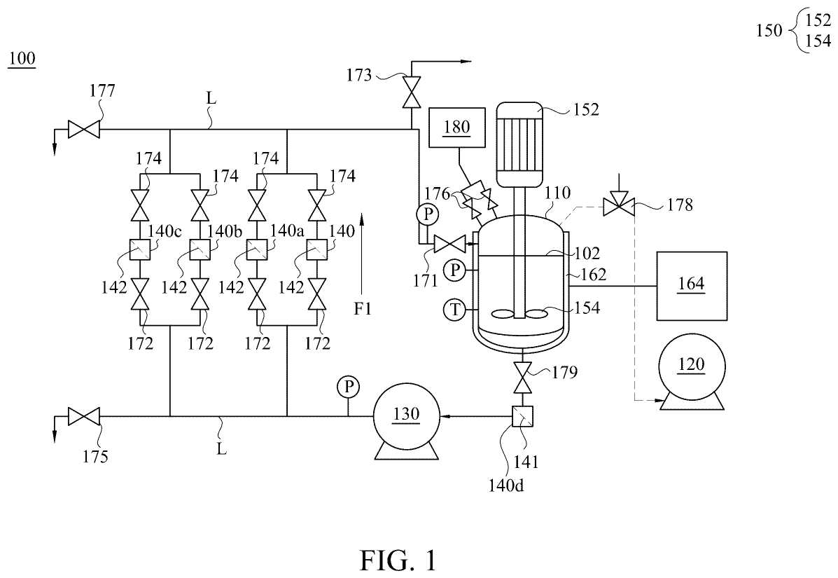

FIG. 1 illustrates a schematic diagram of a dissolving and degassing equipment 100 according to an embodiment of the present disclosure. As shown, the dissolving and degassing equipment 100 includes a dissolution tank 110, a vacuum pump 120, a circulation pump 130, and at least one filter 140. The dissolution tank 110 is configured to accommodate dope 102. The dope 102 is formed by dissolving raw materials and a solvent of spinning stock solution. The dope 102, after undergoing degassing and impurity removal by the dissolving and degassing equipment 100, can form high-purity and high-degassing-degree spinning stock solution usable for producing fibers. The term “degassing” used herein means removing bubbles in the dope 102. The dope 102 in a circulation pipeline L may also be referred to as spinning stock solution. The vacuum pump 120 is connected to a top portion of the dissolution tank 110. The circulation pump 130 is connected to a bottom portion of the dissolution tank 110. In some embodiments, the circulation pump 130 may be a gear pump. During operation, the vacuum pump 120 can create a negative pressure environment (e.g., 0.9 bar) in the dissolution tank 110, as well as the circulation pipeline L and the filter 140, to remove the bubbles in the dope 102. The circulation pump 130 can draw the dope 102 from the dissolution tank 110, causing the dope 102 to pass through the filter 140 and return to the dissolution tank 110, thereby forming a circulation loop. Furthermore, the filter 140 is connected to the circulation pump 130 and the dissolution tank 110. That is, the filter 140 is located downstream of the circulation pump 130 and upstream of the dissolution tank 110.

In the present embodiment, the dissolving and degassing equipment 100 includes a plurality of filters 140, 140a, 140b, 140c, but the number of the filters is not limited to four. Additionally, the filters 140, 140a, 140b, 140c are arranged in parallel and can be switched according to actual demands.

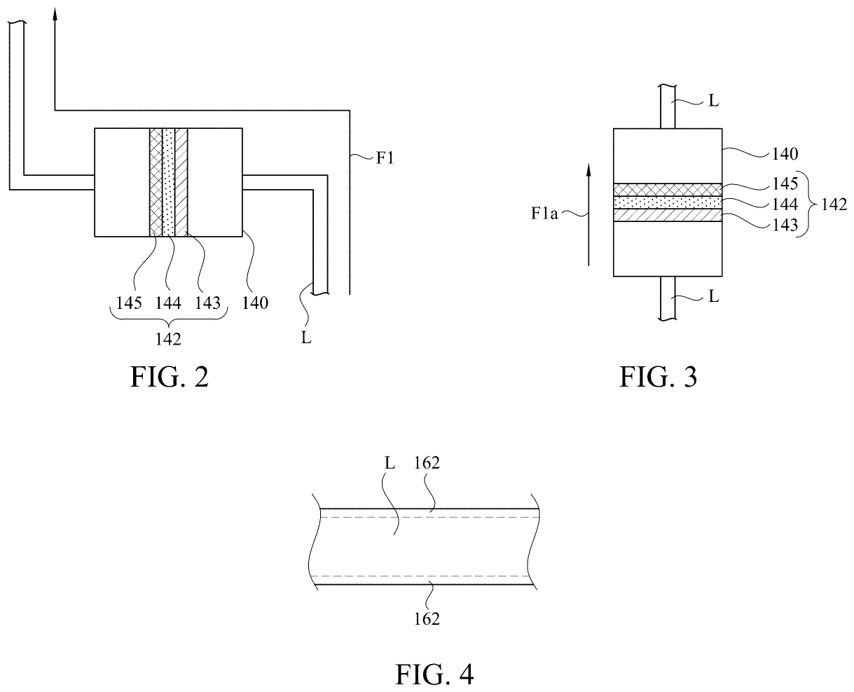

FIG. 2 illustrates an enlarged schematic diagram of the filter 140 and the circulation pipeline L of FIG. 1. Referring simultaneously to FIG. 1 and FIG. 2, the filter 140 has plural sieves 142, and the sieves 142 have different numbers of meshes, and can capture impurities with different sizes and bubbles in the dope 102 drawn from the dissolution tank 110. The term “number of meshes” herein refers to mesh count or mesh, meaning the number of meshes in a sieve per square inch. The sieves 142 include a first sieve 143, a second sieve 144, and a third sieve 145, and the second sieve 144 is located between the first sieve 143 and the third sieve 145. In such a configuration, the dope 102 in the circulation pipeline L can sequentially pass through the first sieve 143, the second sieve 144, and the third sieve 145. In the present embodiment, a number of meshes of the second sieve 144 is greater than a number of meshes of the first sieve 143 and a number of meshes of the third sieve 145, and the number of meshes of the first sieve 143 is greater than the number of meshes of the third sieve 145. In another embodiment, the number of meshes of the first sieve 143 may be equal to the number of meshes of the third sieve 145. The number of meshes of the second sieve 144 may be 200 to 500 per square inch, most preferably 350 to 400. For example, the number of meshes of the first sieve 143 may be 80, the number of meshes of the second sieve 144 may be 350, and the number of meshes of the third sieve 145 may be 30. The material of the third sieve 145 may be different from the materials of the first sieve 143 and the second sieve 144. For example, the material of the third sieve 145 may be metal (e.g., stainless steel material) to have a greater structural strength, thereby providing a support force for the first sieve 143 and the second sieve 144.

In the present embodiment, the filter 140 is located at a horizontal portion of the circulation pipeline L. The dope 102 before entering the filter 140 flows upward, then flows horizontally through the first sieve 143, the second sieve 144, and the third sieve 145 of the filter 140, subsequently flows out of the filter 140 and flows upward again, thereby forming a flow path F1. Such a design allows technicians to disassemble or install the sieves conveniently.

FIG. 3 illustrates an enlarged schematic diagram of the filter 140 and the circulation pipeline L according to another embodiment of the present disclosure. The difference between this embodiment and the embodiment of FIG. 2 is that the dope 102 (see FIG. 1) flows upward to form a flow path Fla before entering the filter 140 in FIG. 3, when passing through the first sieve 143, the second sieve 144, and the third sieve 145 of the filter 140 in FIG. 3, and after flowing out of the filter 140 in FIG. 3.

Referring to FIG. 1, specifically, since the vacuum pump 120 is connected to the top portion of the dissolution tank 110, the circulation pump 130 is connected to the bottom portion of the dissolution tank 110, and the filter 140 having plural sieves 142 is connected to the circulation pump 130 and the dissolution tank 110, it is possible to utilize the vacuum pump 120 to remove gas from the high-viscosity (e.g., 300-5000 Pa-s) dope 102 in the dissolution tank 110, thereby promoting degassing. Furthermore, the design in which the sieves 142 (e.g., the first sieve 143, the second sieve 144, and the third sieve 145 as described previously in FIG. 2) in the filter 140 have different numbers of meshes enables the capture of impurities and additional bubbles in the dope 102 drawn from the dissolution tank 110 by the circulation pump 130. As such, the dissolving and degassing equipment 100 can provide a uniform, bubble-free, and impurity-free spinning stock solution, which is beneficial to the spinning processes in subsequent stages and to the physical properties of the formed fibers, thereby improving the product yield rate.

In the present embodiment, the dissolving and degassing equipment 100 further includes an additional filter 140d and a switching valve 179. The filter 140d is located downstream of the dissolution tank 110 and upstream of the circulation pump 130, and has a sieve 141. A number of meshes of the sieve 141 of the filter 140d may be 20, which is less than the number of meshes of the third sieve 145 (see FIG. 2). The filter 140d is the filter closest to the dissolution tank 110 and serves as a primary-stage filter, and thus it can employ the smallest number of meshes (i.e., largest aperture). The switching valve 179 is located between the dissolution tank 110 and the filter 140d, and needs to be closed before a dissolution state occurs (when the raw materials and the solvent in the dissolution tank 110 are in a separated state) and opened after the raw materials and the solvent dissolve and infiltrate each other, allowing the mixture to enter the circulation pipeline L.

Furthermore, the dissolving and degassing equipment 100 may further include a stirrer 150 and a temperature control system having a heating jacket 162 and a heating and temperature controller 164. The stirrer 150 extends from the top portion of the dissolution tank 110 into the dissolution tank 110, and enables the raw materials and the solvent of the spinning stock solution to be stirred and dissolved into the dope 102, thereby improving uniformity. The stirrer 150 may include a motor 152 and a blade 154. The motor 152 is located above the top portion of the dissolution tank 110. The blade 154 is located in the dissolution tank 110 and connected to the motor 152. Therefore, the blade 154 can be driven by the motor 152 to rotate and stir the dope 102, which is beneficial for degassing and uniformity. The heating jacket 162 is sleeved on the dissolution tank 110 for heat preservation purposes, e.g., covering the side walls and bottom surface of the dissolution tank 110. Additionally, the heating jacket 162 can also be sleeved on the circulation pipeline L, as shown in FIG. 4. The heating jacket 162 may be a jacket structure. In some embodiments, the heating jacket 162 can heat the dissolution tank 110 using methods such as hot oil circulation, oil bath circulation, or electric heating. The heating and temperature controller 164 serves to provide a heat source and temperature control. For example, the heating and temperature controller 164 may be connected to the heating jacket 162. The heating jacket 162 can heat or maintain the temperature of the dope 102 (e.g., 80-150° C.) to ensure thermal stability during processing.

In the present embodiment, the dissolving and degassing equipment 100 further includes a pressurization valve 176 and a vacuum valve 178. The pressurization valve 176 is connected to the top portion of the dissolution tank 110 and an air compressor 180 to introduce pressurized air during the circulation step of the dope 102, so that the dope 102 passes through the filter 140d and is drawn by the circulation pump 130. The vacuum valve 178 is connected to the dissolution tank 110 and the vacuum pump 120. When the dope 102 undergoes dissolution and degassing steps in the dissolution tank 110, the vacuum valve 178 is opened to form a negative pressure environment, which is beneficial for degassing the dope 102.

The dissolving and degassing equipment 100 further includes switching valves 172 and 174. The switching valve 172 is located downstream of the circulation pump 130 and upstream of the filter 140, and the switching valve 174 is located downstream of the filter 140 and upstream of the dissolution tank 110. When a particular filter 140 allows the dope 102 in the circulation pipeline L to pass through, the switching valves 172 and 174 upstream and downstream of the filter 140 are in an open state. When the flow rate of the dope decreases (e.g., due to blockage), the switching valves 172, 174 upstream and downstream of the filter 140 can be closed, and the switching valves 172 and 174 upstream and downstream of an additional filter 140 (e.g., a backup filter) can be opened, so that the dope 102 can have impurities removed and be degassed by the additional filter 140.

In some embodiments, the dissolving and degassing equipment 100 may further include switching valves 171, 173, 175, and 177 to control the flow direction of the dope 102. The switching valve 171 can control whether the dope 102 in the circulation pipeline L flows back to the dissolution tank 110 for recirculation. The switching valve 173 can control whether the dope 102 in the circulation pipeline L is transmitted to the spinning equipment for subsequent spinning processes. The switching valves 175 and 177 can allow the dope 102 before entering the filter 140 and after flowing out of the filter 140 to flow out, respectively, thereby facilitating monitoring of the impurity and degassing state of the dope 102. Additionally, a pressure gauge P, a thermometer T, and a flow meter may be optionally disposed on the dissolution tank 110 and the circulation pipeline L to monitor whether temperature and pressure are normal, and corresponding controllers can automatically adjust the operating parameters of respective portions.

When the dissolving and degassing equipment 100 is in use, the raw materials and the solvent of the spinning stock solution can be placed into the dissolution tank 110 and initially dissolved into the dope 102 via heating and stirring. Subsequently, the circulation pump 130 is actuated to draw the dope 102 from the dissolution tank 110 and cause the dope 102 to flow through the circulation pipeline L and at least one of the filters 140, 140a, 140b, and 140c. Simultaneously, the vacuum pump 120 is actuated to create a negative pressure environment in the entire system including the dissolution tank 110, the circulation pipeline L, and the filters 140, 140a, 140b, and 140c. Dissolution, filtration, degassing, and circulation flow are performed concurrently in this step to produce a high-purity and high-degassing-degree spinning stock solution.

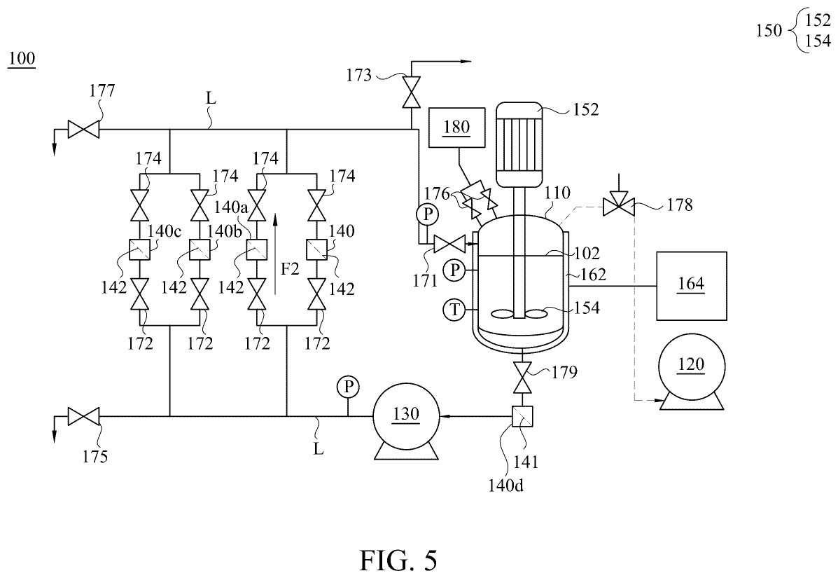

FIG. 5 illustrates a schematic diagram of the dissolving and degassing equipment 100 of FIG. 1 after the filter 140 is switched to another filter 140a. Referring simultaneously to FIG. 1 and FIG. 5, when the flow rate of the dope 102 passing through the filter 140 in FIG. 1 decreases (e.g., due to blockage), the switching valves 172 and 174 upstream and downstream of the filter 140 can be closed, and the switching valves 172 and 174 upstream and downstream of the filter 140a on the left side of the filter 140 can be opened to cause the dope 102 to pass through the filter 140a instead. In this way, the flow path F1 in FIG. 1 can be switched to a flow path F2 in FIG. 5. However, the above description is merely an example. Users can switch to at least one of the other filters 140a, 140b, or 140c as needed.

It should be understood that the connection relationships, materials, and advantages of the previously described components will not be repeated. In the following description, the dissolving and degassing equipment 100 applied to a spinning equipment will be explained.

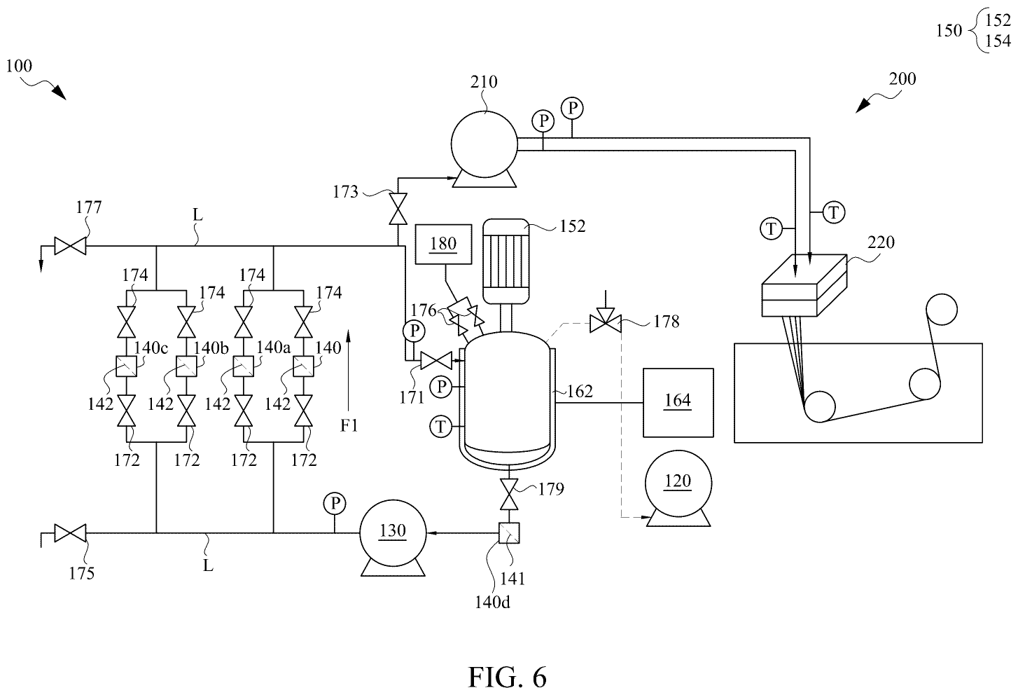

FIG. 6 illustrates a schematic diagram of the dissolving and degassing equipment 100 of FIG. 1 when connected to a spinning equipment 200. The spinning equipment 200 includes a feed pump 210 and a spinneret assembly 220. The feed pump 210 is connected to the switching valve 173 and can receive the dope 102 (i.e., the spinning stock solution) that has undergone impurity removal and degassing by the dissolving and degassing equipment 100. The spinning stock solution is then transmitted to the spinneret assembly 220, and can be filtered again and pressurized to make the pressure uniform, after which yarns (e.g., fibers) are subsequently formed.

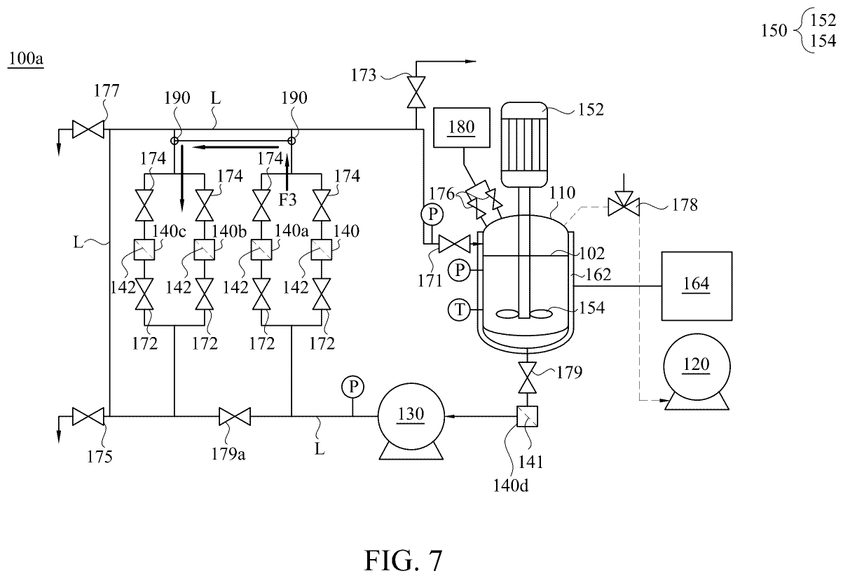

FIG. 7 illustrates a schematic diagram of a dissolving and degassing equipment 100a according to another embodiment of the present disclosure. The difference between this embodiment and the embodiment of FIG. 1 is that the filters 140 and 140a of the dissolving and degassing equipment 100a and filters 140b and 140c are arranged in series, and a switching valve 179a, two two-way valves 190, and the circulation pipeline L oriented vertically on the left side of FIG. 7 are further included. Such a configuration can form a flow path F3.

The foregoing outlines the features of several embodiments to enable those skilled in the art to better understand the aspects of the present disclosure. Those skilled in the art should understand that they may readily use the present disclosure as a basis for designing or modifying other processes and structures to accomplish the same objectives and/or achieve the same advantages as the embodiments described herein. Those skilled in the art should also recognize that such equivalent constructions do not depart from the spirit and scope of the present disclosure, and that various changes, substitutions, and alterations may be made herein without departing from the spirit and scope of the present disclosure.

What is claimed is:

1. A dissolving and degassing equipment, comprising:
a dissolution tank configured to accommodate dope;
a vacuum pump connected to a top portion of the dissolution tank and configured to remove bubbles from the dope;
a circulation pump connected to a bottom portion of the dissolution tank and configured to draw the dope from the dissolution tank; and
at least one filter connected to the circulation pump and the dissolution tank, and located downstream of the circulation pump and upstream of the dissolution tank, wherein the filter has a plurality of sieves with different numbers of meshes, configured to capture impurities of different sizes and additional bubbles in the dope drawn from the dissolution tank.

2. The dissolving and degassing equipment according to claim 1, wherein the sieves comprise a first sieve, a second sieve and a third sieve, and the second sieve is located between the first sieve and the third sieve, such that the dope is allowed to sequentially pass through the first sieve, the second sieve, and the third sieve.

3. The dissolving and degassing equipment according to claim 2, wherein a number of meshes of the second sieve is greater than a number of meshes of the first sieve and a number of meshes of the third sieve, and the number of meshes of the first sieve is greater than or equal to the number of meshes of the third sieve.

4. The dissolving and degassing equipment according to claim 3, wherein the number of meshes of the second sieve is 200 to 500 per square inch.

5. The dissolving and degassing equipment according to claim 4, wherein the number of meshes of the second sieve is 350 to 400 per square inch.

6. The dissolving and degassing equipment according to claim 3, further comprising:
an additional filter located downstream of the dissolution tank and upstream of the circulation pump, and having an additional sieve, wherein its number of meshes is less than the number of meshes of the third sieve.

7. The dissolving and degassing equipment according to claim 6, further comprising:
a switching valve located between the dissolution tank and the additional filter.

8. The dissolving and degassing equipment according to claim 1, further comprising:
a stirrer extending from the top portion of the dissolution tank into the dissolution tank, and configured to enable raw materials and a solvent of spinning stock solution to be dissolved into the dope.

9. The dissolving and degassing equipment according to claim 8, wherein the stirrer comprises:
a motor located above the top portion of the dissolution tank; and
a blade located in the dissolution tank and connected to the motor.

10. The dissolving and degassing equipment according to claim 1, further comprising:
a heating and temperature controller; and
a heating jacket sleeved on the dissolution tank and a circulation pipeline, wherein the heating and temperature controller is connected to the heating jacket.

11. The dissolving and degassing equipment according to claim 1, further comprising:
a pressurization valve connected to the top portion of the dissolution tank and an air compressor; and
a vacuum valve connected to the dissolution tank and the vacuum pump.

12. The dissolving and degassing equipment according to claim 1, further comprising:
two switching valves, wherein one of the two switching valves is located downstream of the circulation pump and upstream of the filter, and the other of the two switching valves is located downstream of the filter and upstream of the dissolution tank.

13. The dissolving and degassing equipment according to claim 1, comprising a plurality of the filters arranged in parallel.

14. The dissolving and degassing equipment according to claim 1, comprising a plurality of the filters arranged in series.

15. A dissolving and degassing equipment, comprising:
a dissolution tank configured to accommodate dope;
a stirrer extending from a top portion of the dissolution tank into the dissolution tank, and configured to enable raw materials and a solvent of spinning stock solution to be dissolved into the dope;
a circulation pump connected to a bottom portion of the dissolution tank and configured to draw the dope from the dissolution tank; and
at least one filter connected to the circulation pump and the dissolution tank, and located downstream of the circulation pump and upstream of the dissolution tank, wherein the filter has a plurality of sieves with different numbers of meshes, configured to capture impurities of different sizes and bubbles in the dope drawn from the dissolution tank.
